(19) United States
(12) Patent Application Publication
(10) Pub. No.: US 2024/0208433 A1
(43) Pub. Date: Jun. 27, 2024

(54) DIGITAL CAMERA RECHARGING AND POSITIONING SYSTEM

(71) Applicant: Winnebago Industries, Inc., Eden Prairie, MN (US)

(72) Inventor: John Bonczyk, Minnetonka, MN (US)

(21) Appl. No.: 18/393,601

(22) Filed: Dec. 21, 2023

Related U.S. Application Data
(60) Provisional application No. 63/435,382, filed on Dec. 27, 2022.

(51) Int. Cl. B60R 11/04; H04N 23/667

(52) U.S. Cl. CPC B60R 11/04; H04N 23/667; B60R 2011/0005

(57) ABSTRACT

A recreational vehicle including a body with a cab area and a living space area, where the cab area includes a dashboard. A first base is attached to the dashboard, and a digital camera assembly is arranged to be removably coupled to the first base. The digital camera assembly includes a digital camera. A button is positioned in the cab area and physically separate from the digital camera assembly and the base. The button is communicatively coupled to the digital camera and configured to selectively activate the digital camera to capture an image when pressed.

### CROSS REFERENCE TO RELATED APPLICATION

This application claims priority to U.S. Provisional Application No. 63/435,382, filed Dec. 27, 2022, which is herein incorporated by reference in its entirety.

### SUMMARY

In certain embodiments, a recreational vehicle includes a body with a cab area and a living space area, and the cab area includes a dashboard. A first base is attached to the dashboard, and a digital camera assembly is arranged to be removably coupled to the first base. The digital camera assembly includes a digital camera. A button is positioned in the cab area and physically separate from the digital camera assembly and the base. The button is communicatively coupled to the digital camera and configured to selectively activate the digital camera to capture an image when pressed.

In certain embodiments, a digital camera kit includes component parts capable of being assembled to be removably attached to each other and/or to a vehicle. The digital camera kit includes the combination of: a first base comprising a first magnet and a power source, a second base comprising a second magnet, a digital camera assembly including a digital camera and comprising a third magnet for magnetically coupling to the first magnet and the second magnet, and an actuator for being communicatively coupled to the digital camera.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a recreational vehicle, in accordance with certain embodiments of the present disclosure.

FIG. 2 shows a schematic floor plan of the recreational vehicle of FIG. 1, in accordance with certain embodiments of the present disclosure.

FIG. 3 shows a digital camera system, in accordance with certain embodiments of the present disclosure.

FIGS. 4 and 5 show parts of the digital camera system and a dashboard of the recreational vehicle, in accordance with certain embodiments of the present disclosure.

FIG. 6 show parts of the digital camera system positioned within a living space area of the recreational vehicle, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope the appended claims.

### DETAILED DESCRIPTION

The present disclosure features digital camera systems that provide various benefits in connection with using recreational vehicles. As one example, certain embodiments of the present disclosure allow passengers of a recreational vehicle to quickly and selectively capture images (e.g., still images or video) of surrounding scenery when in transit. As another example, certain embodiments of the present disclosure allow for a digital camera assembly to be selectively positioned at different positions around a recreational vehicle. As another example, certain embodiments of the present disclosure allow for a digital camera system to monitor the recreational vehicle when passengers are away from the recreational vehicle.

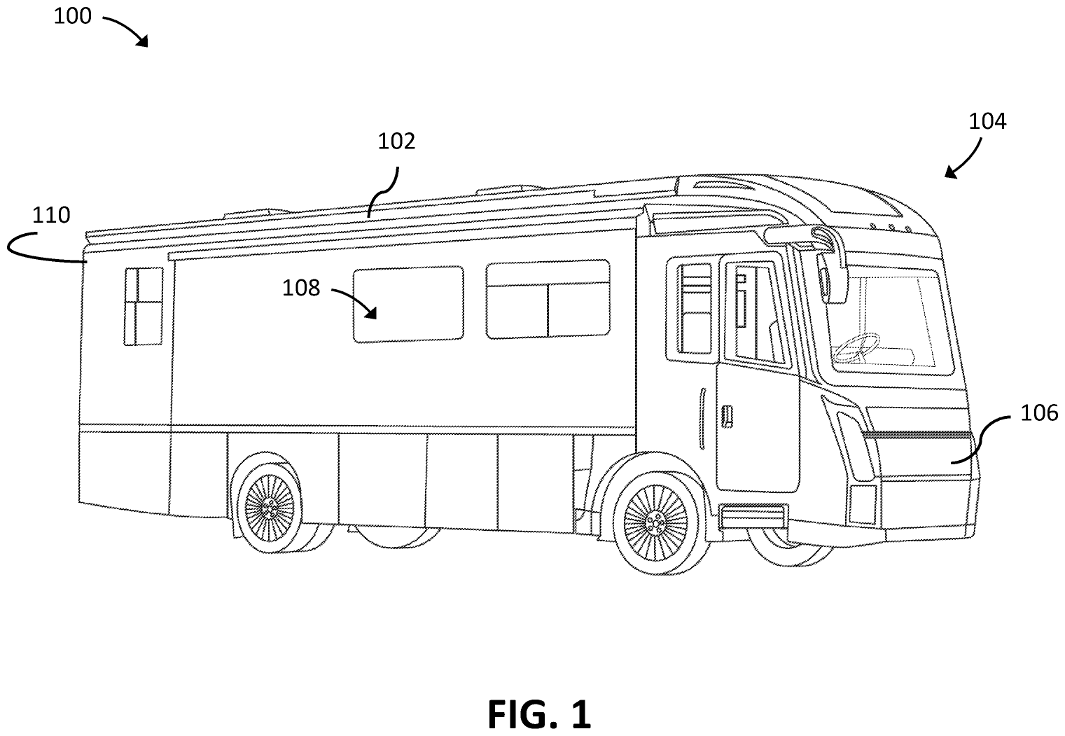

FIG. 1 shows a recreational vehicle 100 having a body 102 that houses a cab area 104 at a front end 106 of the recreational vehicle 100 and a living space area 108 positioned between the cab area 104 and a rear end 110 of the recreational vehicle 100. Although FIG. 1 shows what is typically referred to as a Class A recreational vehicle, embodiments of the present disclosure can be used in other types of motorized recreational vehicles (e.g., Class B recreational vehicles, Class C recreational vehicles, and the like), non-motorized types of recreational vehicles (e.g., 5th wheel trailers, travel trailers, and the like), and marine recreational vehicles.

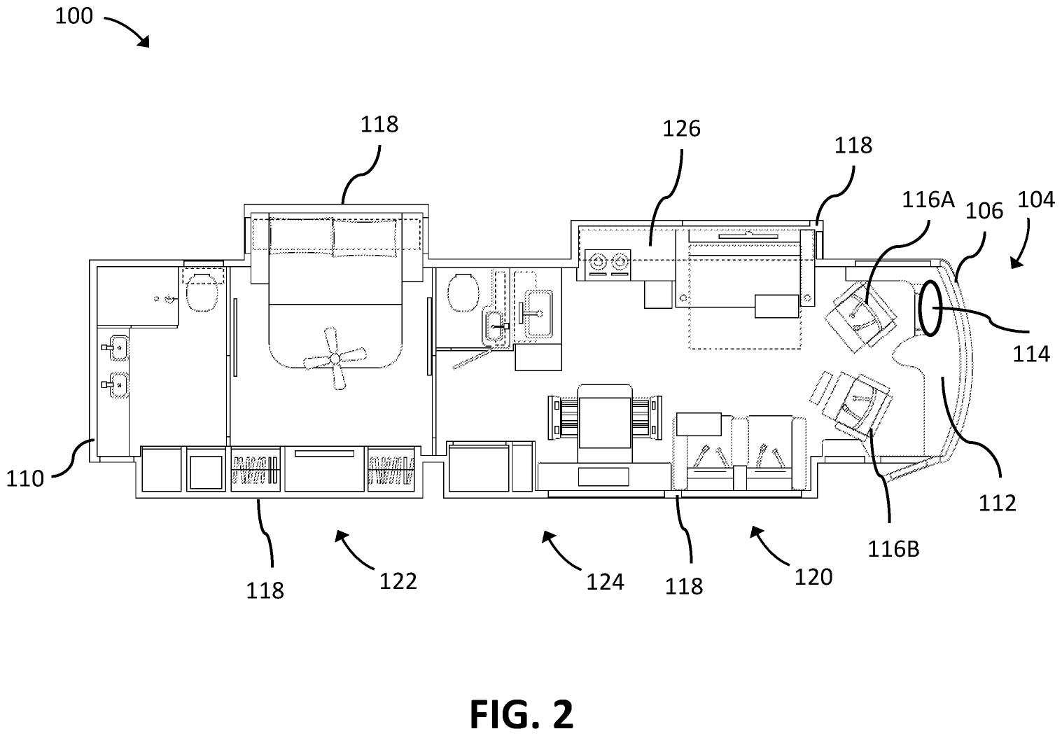

FIG. 2 shows a top-down view of a floorplan of the recreational vehicle 100. The floorplan is just one example of how embodiments of the present disclosure can be used with recreational vehicles such as the recreational vehicle 100.

The recreational vehicle 100 includes a dashboard 112 at the front end 106 and a steering wheel 114 coupled to the dashboard 112. Driver's seat 116A and passenger seat 116B are located in the cab area 104 and can rotate to face various directions (e.g., forward when driving, aft when parked, and therebetween).

The recreational vehicle 100 includes multiple slideouts 118 which can extend and retract. When the recreational vehicle 100 is parked, the slideouts 118 can be extended to increase the amount of space in the living space area 108. Two slideouts are located behind the cab area 104 and on opposing sides of the recreational vehicle 100 in a front living area 120, and two other slideouts are located in a rear bedroom area 122 on opposing sides of the recreational vehicle 100. A kitchen area 124 can be positioned between the front living area 120 and the rear bedroom area 122.

The slideouts 118 and other portions of the recreational vehicle 100 can support various pieces of furniture such as cabinets 126 positioned throughout the living space area 108.

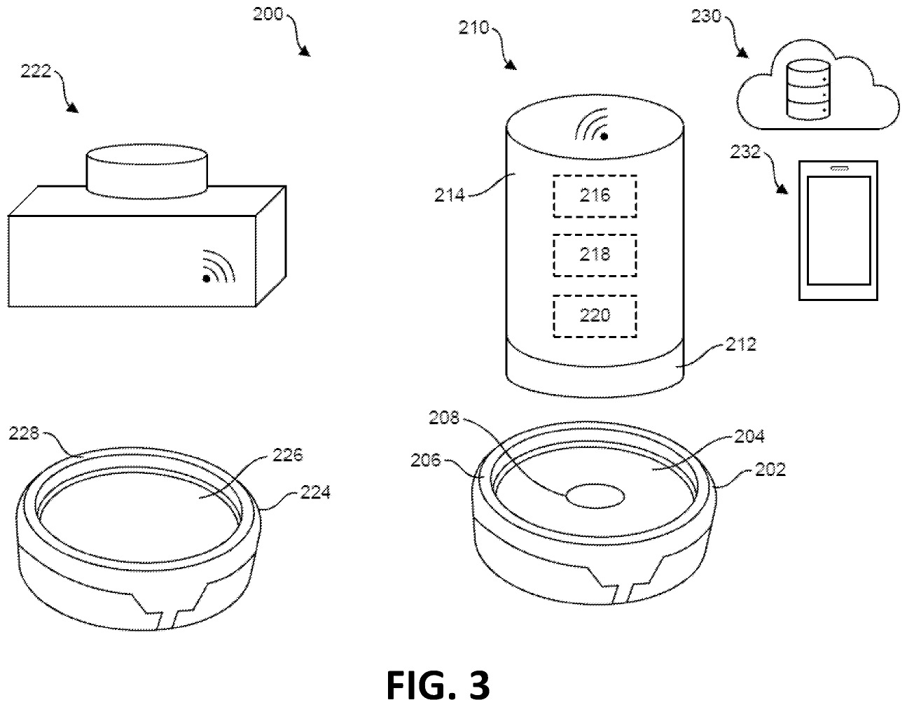

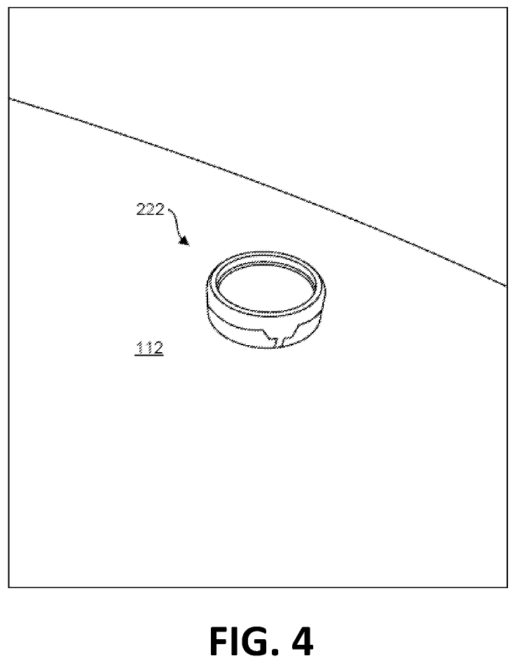

FIG. 3 shows components of a digital camera system 200 (hereinafter the “system 200” for brevity). As will be described in more detail below in connection with FIGS. 4-6, the components of the system 200 can be positioned at various locations around a recreational vehicle such as the recreational vehicle 100 shown in FIGS. 1 and 2.

The system 200 includes a first base member 202 (hereinafter the “first base 202”). The first base 202 is shown as being cylinder shaped but could be other shapes. The first base 202 may include one or more recesses 204 shaped to receive one or more other components of the system 200. For example, the recess 204 can be cylinder shaped, slot shaped, etc.

The first base 202 can also include one or more couplers 206 or coupling devices. In one example, the coupler 206 is a magnet (e.g., a permanent magnet) or a component comprising a magnetic material (e.g., a permanent magnetic material) that emits a magnetic field. In such an example, the magnet/magnetic material can be used to magnetically couple to another magnet/magnetic material of another component of the system 200 such that the first base 202 and the other component are removably or releasably attached to each other. The magnetic coupler can be positioned within (e.g., partially or fully embedded in) the first base 202, such as in a wall that surrounds the recess 204 or in a bottom section of the first base 202. As another example, the coupler 206 can be one or more physical features (e.g., threads, boss, latch) that can be mechanically coupled to another component of the system 200 such that the first base 202 and the other component are removably or releasably attached to each other. In such an example, the threads or other mechanical features can be formed in a wall or other exterior-facing surface of the first base 202.

The first base 202 can include a power source 208 such as a battery charger. The battery charger can be a wireless charger that is designed to transmit power to another one of the components of the system 200. For example, the battery charger can emit a time-varying magnetic field (e.g., via electromagnetic coils) that induces current in a receiver positioned in another component of the system 200. The power source 208 can be electrically coupled to the electrical system of the recreational vehicle 100 such as to the electrical system's battery, alternator, and/or generator. In certain embodiments, the first base 202 includes a user activation device such as a button, switch, slide, or the like to cause the power source 208 to start charging. Additionally or alternatively to the power source 208, the first base 202 can include an interface (e.g., universal serial bus interface or other standardized interface) that can be mechanically and electrically coupled to another component of the system 200 to transmit power and/or data between the components.

The system 200 also includes a digital camera assembly 210, which can be removably coupled to the first base 202. The digital camera assembly 210 can have its own coupler 212 that can couple to the coupler 206 of the first base 202. Just like the coupler 206, the coupler 212 can include a magnet/magnetic material and/or mechanical features that allow the first base 202 and the digital camera assembly 210 to be removably or releasably attached to each other. For example, the respective magnets/magnetic materials can be magnetized to be magnetically coupled/attracted to each other. In embodiments using magnetic couplers, the couplers 206 and 212 can be shaped and magnetized such that the digital camera assembly 210 can be selectively rotated or otherwise positioned so that the direction of the field of view of the digital camera assembly 210 can be changed by users.

The digital camera assembly 210 includes a digital camera 214 (hereinafter the “camera 214”). The camera 214 includes one or more image sensors 216 such as solid-state optical image sensors like charge-coupled device (CCD) and complementary metal oxide semiconductor (CMOS) image sensors.

The camera 214 is powered by a battery 218 (e.g., a rechargeable battery). The battery 218 can be part of the camera 214 itself or be positioned external to the camera 214 somewhere in the digital camera assembly 210. The battery 218 can be charged by the power source 208 of the first base 202. For wireless charging, the camera 214 can include a receiver 220 (e.g., a receiver antenna comprising a conductive material) in which a current is induced by the magnetic field emitted by the power source 208. The induced current can be inputted to the battery 218 to recharge the battery 218. Additionally or alternatively, the digital camera assembly 210 can connect to the interface (e.g., USB interface) of the first base 202 and receive power via the interface. The camera 214 can include other features such as local memory (e.g., solid state memory) for storing images captured by the image sensor 216 and a wireless transmitter for communicating with devices or systems external to the camera 214.

The system 200 also includes an actuator 222 such as a button. The actuator 222 is communicatively coupled to the camera 214 such that the actuator 222 can transmit (or cause transmission of) a signal to the camera 214 which causes the camera 214 to capture an image (and/or multiple images in the form of video clips) via the image sensor 216. For example, when a user presses or otherwise actuates the actuator 222, a signal can be transmitted to the camera 214 so that the camera 214 takes a picture or begins recording video. The actuator 222 can be communicatively coupled to the camera 214 via a wireless connection (e.g., Bluetooth) or wired connection. As such, the actuator 222 can include or be coupled to a transmitter that can communicate signals wirelessly or via a wired connection. Further, the actuator 222 can be physically (e.g., mechanically) separate from other components of the system 200 such as the camera 214.

In addition to the first base 202, the system 200 can include a second base member 224 (hereinafter the “second base 224”). Although only one additional base member is shown in FIG. 3, the system 200 could include additional base members.

The second base 224 can be similarly shaped to the first base 202. For example, the second base 224 can be cylinder shaped (or another shape) and can include a recess 226, which can be shaped to receive the digital camera assembly 210. Similar to the first base 202, the second base 224 can include one or more couplers 228 or coupling devices that correspond to the type of coupler 212 of the digital camera assembly 208. For example, if the coupler 212 is a magnetic coupler, the coupler 228 of the second base 224 can likewise be magnetic. The shape and features of the first base 202 and the second base 224 can be essentially identical except that, in some embodiments, the second base 224 does not include a power source. In such embodiments, the first base 202 is the only base member that has the ability to recharge the battery 218 that powers the camera 214. This provides more flexibility in selecting a location for the second base 224.

The system 200 can also include a remote data storage system 230 such as a server, which includes data storage devices such as hard disk drives and the like. The server 230 can be directly or indirectly communicatively coupled to the camera 214. For example, the camera 214 can be programmed to send images to the server 230 via a modem that is a separate component within the system 200, part of the recreational vehicle, or part of the camera 214 itself. The system 200 can also include a mobile phone 232 with an application (e.g., an app) installed that can access the images and/or videos captured by the camera 214.

In certain embodiments, the system 200 (or certain parts thereof) is sold as a kit. The kit may include, for example, the first base 202, the digital camera assembly 210, the actuator 222, and the second base 224 as well as various items for attaching such components to parts of a recreational vehicle. In other embodiments, the system 200 is installed in a recreational vehicle as the vehicle is being assembled together at a factory.

The figures discussed below show various examples of components of the system 200 installed in the recreational vehicle 100.

FIG. 4 shows the first base 202 attached to the dashboard 112 of the recreational vehicle 100. In certain embodiments, the first base 202 is permanently attached to the dashboard 112. For example, the power source 208 of the first base 202 may be hardwired to the electrical system of the recreational vehicle 100 which may require the first base 202 to maintain its location on the dashboard 112. In other embodiments, the first base 202 can be removably attached to the dashboard 112. For example, the first base 202 may include an adhesive or connector that removably couples the first base 202 to the dashboard 112.

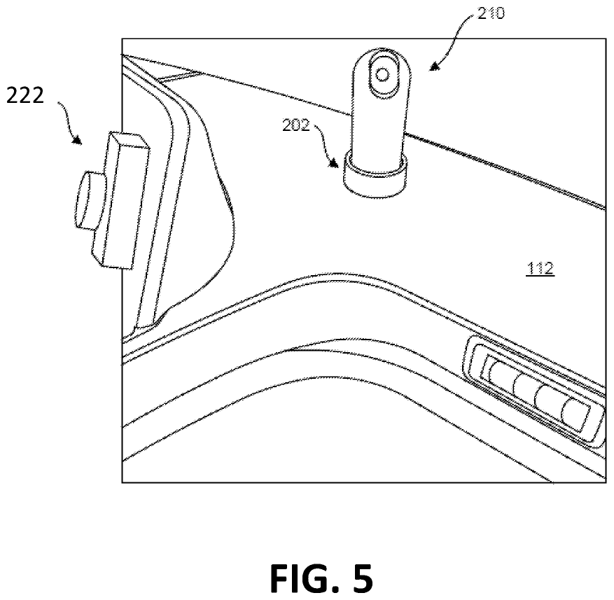

FIG. 5 shows the first base 202 still attached to the dashboard 112 but with the digital camera assembly 210 coupled to the first base 202. As previously noted, the digital camera assembly 208 is removably coupled to the first base 202 (e.g., via the couplers 206 and 212). Further, the position of the digital camera assembly 210 within the first base 202 can be altered (e.g., by rotating the digital camera assembly 210 or a part thereof) such that the field of view captured by the image sensor 216 of the camera 214 can be customized and set by users. For example, during transit, the digital camera assembly 210 is arranged such that the field of view of the image sensor 216 is directed through a front windshield of the recreational vehicle 100. This way, the image sensor 216 can capture images of essentially what the driver and/or passengers see through the windshield during transit.

As previously noted, the actuator 222 can be physically separate from the first base 202 and the digital camera assembly 210 but is communicatively coupled (e.g., via a wireless connection such as Bluetooth or a wired connection) to the digital camera assembly 210. The actuator 222 can be mechanically attached to various parts of the recreational vehicle 100 such as the dashboard 112, the steering wheel 114, or another part located in the cab area where the driver and/or the passengers can access the actuator 222 while remaining sitting in their seat with their seatbelts fastened.

By positioning the actuator 222 at a convenient location, the driver and/or passengers of the recreational vehicle 100 can quickly access the actuator 222 and actuate (e.g., press, switch) the actuator 222 to cause the camera 214 to take a picture or to begin recording video. This functionality allows the driver and/or passengers to be able to capture images of the surrounding scenery without having to spend time finding a camera and/or separately turning on a camera on a smartphone-time which could result in the passengers failing to capture the desired scenery in time. With the digital camera assembly 210 and the actuator 222, the driver and/or passengers of the recreational vehicle 100 can quickly and selectively capture images of surrounding scenery when in transit. As such, the driver and/or passengers can document a trip by collecting images of the scenery as they are in transit. Additionally, the digital camera assembly 210 and the actuator 222 allow the driver and/or passengers to capture images in the event of an accident/wreck. In certain embodiments, the camera 214 (or a device able to control the camera 214) can be programmed to take pictures at defined time internals (e.g., every 5-10 minutes). Further, in certain embodiments, the camera 214 could be voice controlled such that the driver and/or passenger can cause the camera to capture an image based on voice commands.

As noted above, the camera 214 can be directly or indirectly communicatively coupled to the server 230, which can be accessed by the mobile phone 232 (or another device such as a laptop computer) via an app or browser. In certain embodiments, once an image or video is captured, the camera 214 can automatically transmit the image or video to the server 230 when the camera 214 is communicatively coupled to the server 230. As such, the mobile phone 232 or other device can have nearly instantaneous access to images and videos captured by the camera 214. In addition to the actuator 222, in certain embodiments, the mobile phone 232 or another device can use the app or a browser to cause the camera 214 to capture an image or video.

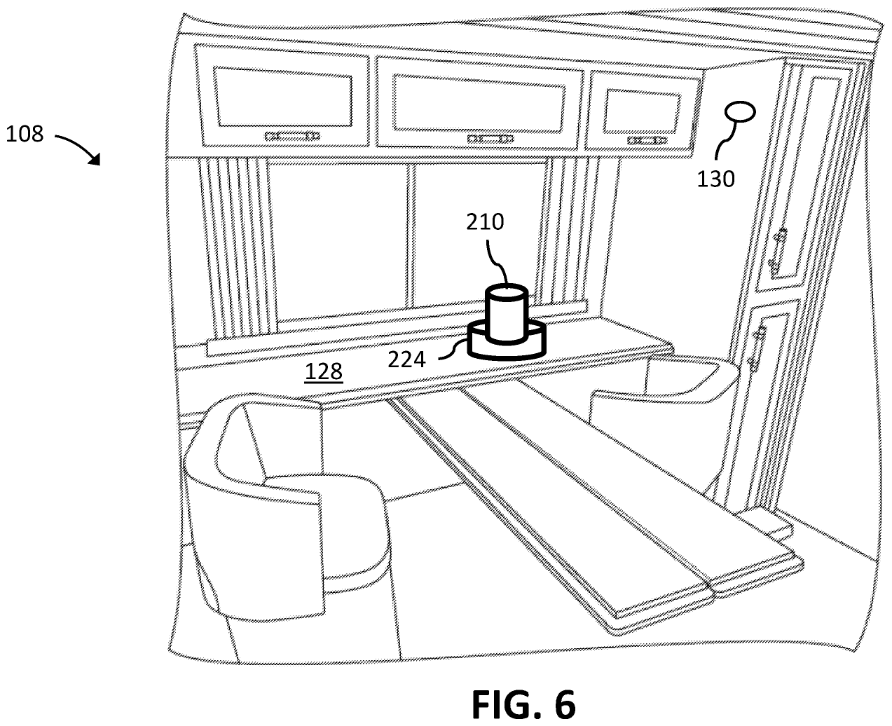

FIG. 6 shows the second base 224 positioned in the living space area 108 of the recreational vehicle 100. For example, the second base 224 can be positioned on and removably coupled to a table 128, cabinet, or other part in the living space area 108. Further, in some embodiments, the second base 224 can be positioned external to the recreational vehicle 100 and used outside.

As shown in FIG. 6, the digital camera assembly 210 is coupled (e.g., removably coupled) to the second base 224 (e.g., via the couplers 228 and 212). The position of the digital camera assembly 210 relative to the second base 224 can be altered such that the field of view captured by the image sensor 216 of the camera 214 can be customized and set by users.

When the digital camera assembly 210 is coupled to the second base 224, the digital camera assembly 210 can be used to monitor the living space area 108. The second base 224 and the digital camera assembly 210 can be positioned such that the image sensor 216 of the camera 214 can face the interior of the recreational vehicle 100 as opposed to facing out a window of the recreational vehicle 100. In this position, the digital camera assembly 210 can be used to monitor a pet when the recreational vehicle 100 is not otherwise occupied.

For example, in certain embodiments, the digital camera assembly 210 is powered on and activated such that a user can access, in real-time, the video captured by the camera 214. For example, the digital camera assembly 210 can be set to continuously record video of the living space area 108 and the user can access the video through the mobile phone 232 (or another device) via the app or a browser. Additionally or alternatively, the digital camera assembly 210 can transmit recorded video to the server 230, which can be then be accessed by the user via the mobile phone 232. In certain embodiments, to conserve battery life, the digital camera assembly 210 can be selectively activated to record images or video instead of continuously recording. For example, a user can utilize the mobile phone 232 or another device can use the app or a browser to cause the camera 214 to capture an image or video as desired instead of continuously. As another example, the digital camera assembly 210 can be communicatively coupled to a motion sensor 130 (e.g., proximity sensor). When the motion sensor 130 detects motion (e.g., a pet's movement), the motion sensor 130 can send a signal that automatically activates the camera 214 to begin to capturing images or video. As such, the digital camera assembly 210 can operate not only as part of a pet monitoring system but can also operate a part of a security system. When in a security system mode, the digital camera assembly 210 can be programmed to send captured images or video to a recording device (e.g., memory or another type of data storage device), the server 230, and/or the mobile phone 232. Further, the mobile phone 232 could automatically receive an alert under certain conditions such as when motion is detected in the living space area 108.

Although the digital camera assembly 210 shown in the Figures and described above was described in the context of a motorhome recreational vehicle, the the digital camera assembly 210 can be used in marine applications or other types of vehicles or trailers.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

I claim:

1. A recreational vehicle comprising:
a body including a cab area and a living space area, the cab area including a dashboard;
a first base attached to the dashboard;
a digital camera assembly arranged to be removably coupled to the first base and including a digital camera; and
a button positioned in the cab area and physically separate from the digital camera assembly and the base, the button communicatively coupled to the digital camera and configured to selectively activate the digital camera to capture an image when pressed.

2. The recreational vehicle of claim 1, wherein the digital camera includes a battery, wherein the first base includes a charger configured to charge the battery.

3. The recreational vehicle of claim 1, wherein the charger is configured to charge the battery wirelessly.

4. The recreational vehicle of claim 1, wherein the first base and the digital camera assembly are removably coupled to each other via one or more magnets.

5. The recreational vehicle of claim 4, wherein the magnets are permanent magnets.

6. The recreational vehicle of claim 1, wherein the button is wirelessly coupled to the digital camera.

7. The recreational vehicle of claim 1, wherein the button is attached to the dashboard.

8. The recreational vehicle of claim 1, further comprising:
a second base arranged to be removably coupled to the digital camera, the second base is positioned in the living space area.

9. The recreational vehicle of claim 8, wherein the second base and the digital camera assembly are removably coupled to each other via one or more magnets.

10. A digital camera kit having component parts being capable of being assembled to be removably attached to each other and/or to a vehicle, the digital camera kit comprising the combination of:
a first base comprising a first magnet and a power source;
a second base comprising a second magnet;
a digital camera assembly including a digital camera and comprising a third magnet for magnetically coupling to the first magnet and the second magnet; and
an actuator for being communicatively coupled to the digital camera.

11. The digital camera kit of claim 10, wherein the second base does not include its own power source
